(19) United States
(12) Patent Application Publication
(10) Pub. No.: US 2025/0111412 A1
(43) Pub. Date: Apr. 3, 2025

(54) INFORMATION PROCESSING DEVICE

(71) Applicant: TOYOTA JIDOSHA KABUSHIKI KAISHA, Aichi-ken (JP)

(72) Inventors: Iwao NITTA, Nagoya-shi (JP); Yasuhide KURIMOTO, Kasugai-shi (JP); Kenji ZAITSU, Nisshin-shi (JP); Sotaro HAYASHI, Okazaki-shi (JP); Ryota SUZUKI, Ikeda-shi (JP)

(21) Appl. No.: 18/902,928

(22) Filed: Oct. 1, 2024

(30) Foreign Application Priority Data
Oct. 3, 2023 (JP) 2023-172264

(51) Int. Cl. G06Q 30/02; G06Q 10/30; G07C 5/10

(52) U.S. Cl. CPC G06Q 30/0278; G06Q 10/30; G07C 5/10

(57) ABSTRACT

An information processing device acquires first data relating to a status of a first vehicle having a driving battery, acquires second data relating to a status of the driving battery, and calculates an evaluation value relating to the first vehicle based on the first data and the second data.

### CROSS-REFERENCE TO RELATED APPLICATION

This application claims priority to Japanese Patent Application No. 2023-172264 filed on Oct. 3, 2023, incorporated herein by reference in its entirety.

### BACKGROUND

### 1. Technical Field

The present disclosure relates to an information processing device.

### 2. Description of Related Art

In recent years, the distribution of battery electric vehicles as used vehicles has increased. As a related disclosure, for example, Japanese Unexamined Patent Application Publication No. 2022-068613 (JP 2022-068613 A) discloses a system for calculating a transaction price of an in-vehicle battery in consideration of a degree of deterioration of the battery.

### SUMMARY

An object of the present disclosure is to appropriately evaluate the value of a vehicle mounted with a driving battery.

A first aspect of the present disclosure relates to an information processing device including a control unit that executes: obtaining first data relating to a status of a first vehicle including a driving battery; acquiring second data relating to a status of the driving battery; and calculating an evaluation value for the first vehicle based on the first data and the second data.

Another aspect of the present disclosure relates to an information processing method that is executed by the device, a program that causes a computer to perform the information processing method, or a computer-readable storage medium storing the program in a non-transitory manner.

According to the present disclosure, it is possible to appropriately evaluate the value of a vehicle mounted with a driving battery.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram for explaining an outline of an evaluation system according to a first embodiment;

FIG. 2 is a diagram for explaining a configuration of a server device, a base terminal, and a business operator terminal;

FIG. 3 is an example of vehicle data stored in a server device;

FIG. 4 is an example of evaluation value data stored in a server device;

FIG. 5 is a sequence diagram of data transmitted and received between devices; and

FIG. 6 is a flowchart of processing executed by the server device.

### DETAILED DESCRIPTION OF EMBODIMENTS

Battery electric vehicle (BEV), plug-in hybrid electric vehicle (PHEV), the number of vehicles mounted with a driving battery and capable of traveling by using electricity as an energy source is increasing.

In general, the evaluation value of an automobile used as a used car is determined by the annual formula or the distance traveled. On the other hand, in recent years, there has been proposed a system or the like that calculates an evaluation value of a battery electric vehicle considering a degree of degradation of a battery or the like.

On the other hand, even in a vehicle equipped with a battery that is deteriorated so as not to be suitable for resale as a used vehicle, when the battery can be recycled, there is a possibility that only the battery can be removed and sold. However, in the conventional evaluation system, only an evaluation value as a vehicle can be calculated, and an appropriate recycling method of a battery cannot be proposed.

In order to solve this problem, it is necessary to calculate both the value as a used vehicle and the value as a battery for the target vehicle.

An information processing device according to a first aspect of the present disclosure includes a control unit. The control unit is configured to acquire first data related to a status of a first vehicle having a driving battery, acquire second data related to a status of the driving battery, and calculate an evaluation value related to the first vehicle based on the first data and the second data.

The first data is data related to the status of the vehicle, and is typically data used to evaluate the value of the first vehicle as a used vehicle, such as a model of the vehicle, a travel distance, and an annual formula.

The second data is data related to the status of the driving battery of the first vehicle. The second data may include, in addition to the data identifying the model of the battery, data relating to the degradation status of the battery, typically State of Health (SoH), the number of charges and discharges, the maximum power value, and the like.
The control unit uses the two types of data in combination to calculate an evaluation value for the first vehicle. The evaluation value obtained here may be the evaluation value of the first vehicle as a used vehicle, or may be the evaluation value of the battery alone.

The control unit may calculate a first evaluation value, which is an evaluation value of the first vehicle as a used vehicle, based on the first data, and may calculate a second evaluation value, which is an evaluation value of the driving battery alone, based on the second data.

If the first evaluation value exceeds the second evaluation value, it is recommended to resell the first vehicle as a used vehicle. Also, if the second evaluation value exceeds the first evaluation value, it is recommended to remove the battery from the first vehicle and resell it as a battery.

The second evaluation value may be either (1) an evaluation value in a case where the driving battery is re-distributed, (2) an evaluation value in a case where the driving battery is rebuilt, or (3) an evaluation value in a case where resources are extracted from the driving battery.

The information processing device according to the present disclosure can propose, for example, whether to recycle the battery by any method according to the deterioration state of the battery. The control unit may determine a recycling method of the battery after acquiring the respective evaluation values. For example, the control unit may determine a recycling method having the highest evaluation value among the above-described items (1) to (3) and propose the recycling method to the user of the apparatus.

Further, the control unit may acquire bid data in which the status of the driving battery and the evaluation value are associated with each other from terminals associated with a plurality of operators, and calculate the second evaluation value based on the second data and the plurality of bid data.

In a case where there are a plurality of battery recycling business operators, the evaluation value that can be presented by each business operator may be collected as bid data, and the final evaluation value (that is, the evaluation value presented by the winning bidder) may be calculated based on the bid data.

Hereinafter, embodiments of the present disclosure will be described with reference to the drawings. A hardware configuration, a module configuration, a functional configuration, etc., described in each embodiment are not intended to limit the technical scope of the disclosure to them only unless otherwise stated.

### First Embodiment

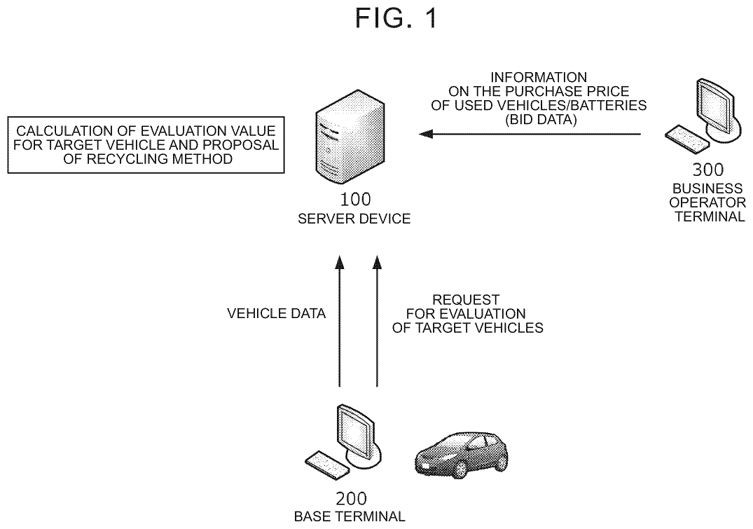

An outline of the evaluation system according to the first embodiment will be described with reference to FIG. 1.

The evaluation system according to the present embodiment includes a server device 100 that evaluates the value of the target vehicle, a base terminal 200 that requests the server device 100 to evaluate the target vehicle, and a business operator terminal 300 corresponding to a business operator that handles a battery or a used vehicle.
In the following description, the “battery” refers to a driving battery included in the target vehicle.

The server device 100 is a device that stores information on a plurality of vehicles and evaluates the value of a designated vehicle (hereinafter, referred to as a target vehicle). The server device 100 proposes a recycling method in which an evaluation value of a target vehicle as a used vehicle and an evaluation value of a battery included in the target vehicle can be calculated individually, and the evaluation value is the highest (in other words, the highest value can be sold).

In the present embodiment, the following is an example of a recycling method for a target vehicle.
(1) A method of selling a target vehicle to a used vehicle seller as a used vehicle In other words, it is sold while maintaining its function as a battery electric vehicle.
(2) A method of removing a battery from a target vehicle and selling it to a used battery distributor
   In this case, the removed battery is incorporated in another vehicle as it is and reused.
(3) A method of removing a battery from a target vehicle and selling it to a rebuild operator of a used battery
   In this case, the removed battery is disassembled and rebuilt (e.g., in cells). The rebuilt battery is redistributed as a used battery.
(4) A method of removing a battery from a target vehicle and selling it to a recycling business operator for raw materials
   In this case, the removed battery is disassembled and recycled as a resource including a rare metal, a rare earth, or the like.

The base terminal 200 is a computer arranged at a maintenance base of the vehicle. Examples of the maintenance base include an automobile repair shop and a dealer. The base terminal 200 executes one of a process of transmitting data about a target vehicle (for example, data representing a condition of a vehicle or a battery) to the server device 100, and a process of interacting with the server device 100 and inquiring the server device 100 of an optimum method for recycling the target vehicle. The data about the target vehicle is hereinafter referred to as vehicle data.

The business operator terminal 300 is a terminal corresponding to an operator that handles used vehicles or batteries. The business operator terminal 300 is, for example, a terminal corresponding to the aforementioned used vehicle seller, the used battery distributor/seller, the used battery rebuild operator, or the raw material recycling operator. The business operator terminal 300 provides the server device 100 with information (hereinafter referred to as evaluation value data) regarding the purchase amount of the used vehicle or the used battery. The evaluation value data is an example of “bid data”.

The server device 100 stores vehicle data and evaluation value data. Then, when an inquiry is made from the base terminal 200, the server device 100 refers to the accumulated data to determine the most appropriate recycling method and sale destination of the vehicle (or battery), and outputs the determined method. As a result, for example, even when there is a vehicle that is almost no value as a used vehicle because the battery is deteriorated, it is possible to provide information such as “selling the battery to the rebuild business operator can obtain more profit than selling the battery as a used vehicle”.

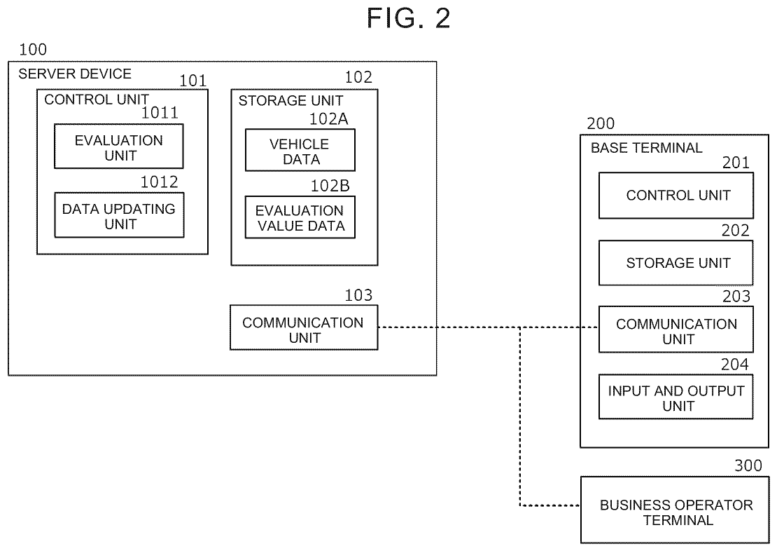

FIG. 2 is a diagram showing the components of the server device 100, the base terminal 200, and the business operator terminal 300 included in the evaluation system according to the present embodiment in more detail. First, the base terminal 200 will be described.

The base terminal 200 is, for example, a computer such as a personal computer, a smartphone, a mobile phone, a tablet computer, or a personal information terminal. The base terminal 200 includes a control unit 201, a storage unit 202, a communication unit 203, and an input/output unit 204.

The control unit 201 is an arithmetic unit that controls the control performed by the base terminal 200. The control unit 201 can be realized by an arithmetic processor such as a Central Processing Unit (CPU).

The control unit 201 accesses the server device 100 and executes a function of performing an interaction. The function may be realized by a web browser operating in the base terminal 200 or by dedicated application software.

The storage unit 202 includes a main storage device and an auxiliary storage device. The main storage device is a memory in which a program executed by the control unit 201 and data used by the control program are expanded. The auxiliary storage device is a device in which a program executed by the control unit 201 and data used by the control program are stored. The auxiliary storage device may store a package of programs executed by the control unit 201 as an application. Further, an operating system for executing these applications may also be stored. The program stored in the auxiliary storage device is loaded into the main storage device and executed by the control unit 201, so that the processing described below is performed.

The main storage device may include Random Access Memory (RAM) or Read Only Memory (ROM). The secondary storage device may include Erasable Programmable ROM (EPROM) or Hard Disk Drive (HDD). Further, the auxiliary storage device may include a removable medium, that is, a portable recording medium.

The communication unit 203 is a wireless communication interface for connecting the base terminal 200 to a network. The communication unit 203 is configured to be able to communicate with the server device 100 via a mobile communication service such as a radio LAN, a 3G, 4G, or a 5G.

The input/output unit 204 is a unit that receives an input operation performed by a user and presents information to the user. In the present embodiment, a single touch panel display is used. That is, the apparatus includes a liquid crystal display, a control unit thereof, a touch panel, and a control unit thereof.

Next, the server device 100 will be described.

As described above, the server device 100 is a device that collects and accumulates information on the evaluation values of used vehicles and used batteries, determines the most appropriate recycling method of the target vehicle when an inquiry is made from the base terminal 200, and provides the information.

In the present embodiment, the server device 100 may be configured to be capable of executing a Web server for interacting with the base terminal 200. In this case, for example, the base terminal 200 can receive information by accessing Web service using a browser. Note that the server device 100 may provide a service by a unit other than Web server. For example, a service that interacts with dedicated application software installed in the base terminal 200 according to a predetermined protocol may be executed in the server device 100.

The server device 100 can be configured as a computer including a processor such as a CPU and a GPU, a main storage device such as a RAM and a ROM, and an auxiliary storage device such as a EPROM, a hard disk drive, and a removable medium. The secondary storage device stores an operating system (OS), various programs, various tables, and the like. The program stored in the auxiliary storage device is loaded into a work area of the main storage device and executed, and the constituent units and the like are controlled through the execution of the program, so that each function matching a predetermined purpose can be realized, as will be described later. However, some or all of the functions may be implemented by a hardware circuit such as an ASIC or an FPGA.

The server device 100 includes a control unit 101, a storage unit 102, and a communication unit 103.

The control unit 101 is an arithmetic unit that controls the control performed by the server device 100. The control unit 101 can be implemented by an arithmetic processing unit such as a CPU.
The control unit 101 includes two functional modules, an evaluation unit 1011 and a data updating unit 1012. Each functional module may be implemented by execution of a stored program by the CPU.

The evaluation unit 1011 performs an interaction with the base terminal 200 to evaluate the target vehicle, and outputs a result thereof.

Specifically, the evaluation unit 1011 first acquires data (vehicle data) related to the target vehicle from the base terminal 200. The vehicle data includes a plurality of items used as evaluation criteria for the used vehicle, such as a model of the target vehicle, an annual formula, and a travel distance.
Further, the evaluation unit 1011 secondly determines the most appropriate recycling method of the target vehicle based on the vehicle data and the evaluation value data (described later) stored in the storage unit 102. As described above, the recycling method of the target vehicle is one of “sale as a used vehicle” and “sale as a used battery”. When a vehicle is sold as a used battery, the seller of the used battery is one of a “seller of the used battery”, a “rebuild operator of the used battery”, and a “recycle operator of the raw material”. The evaluation unit 1011 may provide the base terminal 200 with data related to the recommended recycling method, the business operator to be sold, and the evaluation value.
A specific method will be described later.

The data updating unit 1012 interacts with the business operator terminal 300 to collect data related to the evaluation value of the used vehicle or the battery on a per-operator basis.

Here, the evaluation value of the used car and the battery will be described. When the target vehicle is sold as a used vehicle, the evaluation value may vary depending on the model of the target vehicle, the year, the travel distance, the presence or absence of a restoration history, and the like. The data updating unit 1012 acquires data (bid data) including these conditions and evaluation values from the business operator handling the sale and purchase of the used vehicle. The bid data can also be said to be data indicating the intention to purchase the used car that meets the condition at the presented evaluation value. The data updating unit 1012 stores the acquired data in the storage unit 102 as used vehicle evaluation value data.

In addition, when the battery removed from the target vehicle is sold, the evaluation value may vary depending on State of Health (SoH) of the battery, the number of times of charging and discharging, the maximum power, and the like.

SoH represents a ratio of the present full charge capacity to the initial full charge capacity. For example, a battery with a SoH of 80% can store 80% of its original full charge capacity. The number of times of charging and discharging is the number of times of charging and discharging from a new product. The number of charges and discharges is counted as one at the time when the power of the battery is used by 100%. The maximum output is the maximum power that the battery can output. If the battery is degraded, the maximum power may be limited. That is, there are also used batteries that have a lower maximum output than a new one.
Note that other indices may be used as long as the indices indicate the degree of deterioration of the battery. For example, indicators such as an operation history of a safety device included in a battery and a state of a plurality of cells may be used.

The evaluation value of the battery can be determined by an operator handling the battery based on these indications. Business operators that handle batteries can be roughly classified into, for example, business operators that sell batteries as they are, business operators that disassemble and rebuild batteries, business operators that disassemble and recycle batteries, and the like. The data updating unit 1012 acquires data (bid data) including an index and an evaluation amount to be satisfied from the business operator terminal 300 of each enterprise. The bid data may be data indicating an intention to purchase the battery that meets the condition at the presented evaluation value. The data updating unit 1012 stores the acquired data as battery evaluation value data in the storage unit 102.

In the following description, the used vehicle evaluation value data and the battery evaluation value data are collectively referred to as “evaluation value data”.

The storage unit 102 includes a main storage device and an auxiliary storage device. The main storage device is a memory in which a program executed by the control unit 101 and data used by the control program are expanded. The auxiliary storage device is a device in which a program executed by the control unit 101 and data used by the control program are stored.

Further, the storage unit 102 stores the vehicle data and the evaluation value data described above.

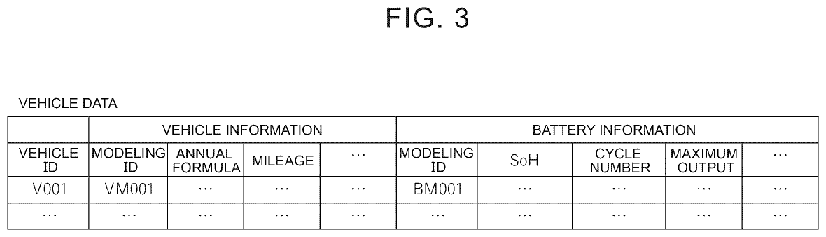

The vehicle data 102A is data related to the target vehicle transmitted from the base terminal 200. The vehicle data 102A includes information for calculating an evaluation value of the target vehicle as a used vehicle and information for calculating an evaluation value as a battery.
FIG. 3 is an exemplary vehicle data 102A. As shown, the vehicle data 102A includes vehicle information and battery information as well as vehicle identifiers (vehicle ID fields). The vehicle information is information for calculating a value as a used vehicle, and the battery information is information for calculating a value as a battery.

In the vehicle ID field, an identifier (e.g., a cart number or a Vehicle Identification Number (VIN)) that uniquely identifies the target vehicle is stored.

The model ID field, the year type field, the travel distance field, and the like are used. In the model ID field, an identifier for specifying a model or a grade of the vehicle is stored. In the year formula field, information related to the year formula of the target vehicle is stored. In the travel distance field, information related to the travel distance of the target vehicle is stored.

The battery data includes a model ID field, a SoH field, a charge/discharge frequency field, and a max-output field. In the model ID field, an identifier for specifying a model or a grade of the battery is stored. In SoH field, a value (percentage) representing a ratio of the present full charge capacity to the initial full charge capacity is stored. The charge/discharge count field stores the number of times of charge/discharge from the new state of the battery. The number of charges and discharges is counted as one at the time when the power of the battery is used by 100%. In the maximum output field, a value representing the maximum power that the battery can output is stored.

The battery information may be generated based on a result of the battery measurement performed at a vehicle base (for example, a maintenance factory, a dealer, or the like).
The vehicle data may be generated or updated based on the data transmitted from the base terminal 200.

The evaluation value data 102B is a set of bid data transmitted from the business operator terminal 300. By referring to the evaluation value data 102B, it is possible to obtain an evaluation value as a used vehicle or an evaluation value as a battery for the target vehicle.

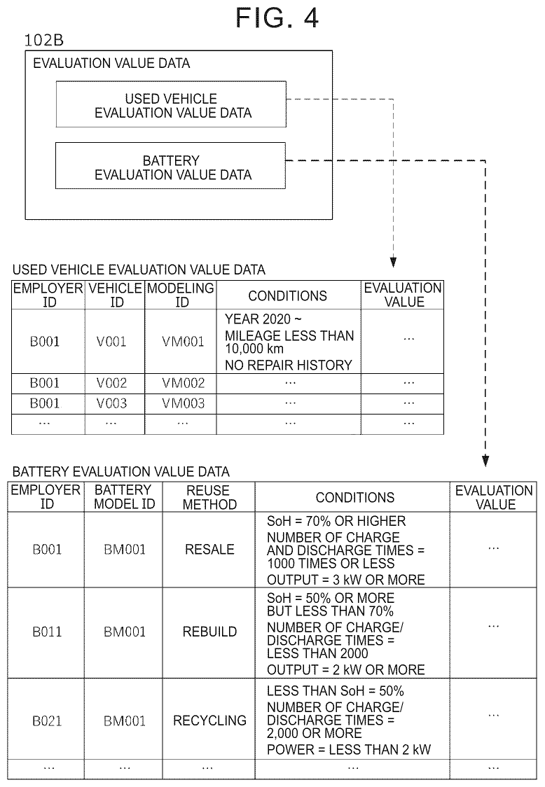

FIG. 4 illustrates an exemplary evaluation value data 102B. As illustrated, the evaluation value data 102B includes two types of data: used vehicle evaluation value data and battery evaluation value data. The used vehicle evaluation value data is data in which the evaluation value in the case where the target vehicle is evaluated as the used vehicle is described. The battery evaluation value data is data in which an evaluation value in a case where the target vehicle is evaluated as a battery is described. The evaluation value indicates a purchase amount presented by an operator who handles a used car or a used battery.

As illustrated, the used vehicle evaluation value data includes an identifier of the operator who presented the valuation, an identifier of the vehicle and the model, a condition, and a valuation. The condition is, for example, a condition to be satisfied by the vehicle, such as an annual formula or a traveling distance.

Further, as illustrated, the battery evaluation value data includes an identifier of the operator who has presented the evaluation value, an identifier of the battery model, a reuse method, a condition, and an evaluation value. The reuse method is a method of reusing a purchased battery. In the present embodiment, “resale”, “rebuild”, and “resource recovery” are assumed as the reuse method. The resale is a form in which the removed battery is resold as it is. The rebuild is a form in which the removed battery is disassembled (for example, in units of cells) and a necessary treatment is performed (for example, the cells are replaced) to form a new battery. Resource recycling is a form in which a removed battery is completely disassembled and recycled as a resource.
The condition is a condition to be satisfied by the battery, and is, for example, a value of SoH, a number of times of charging and discharging, a maximal value of the power, and the like.

The above-described data may be constructed by a program of a database management system (DBMS) executed by a processor managing data stored in a storage device. In this case, each data may be, for example, a relational database.

The communication unit 103 is a communication interface for connecting the server device 100 to a network. The communication unit 103 includes, for example, a network interface board and a wireless communication interface for wireless communication.

Next, the business operator terminal 300 will be described.

The business operator terminal 300 is a terminal used by an operator who handles used vehicles or batteries. In the present embodiment, the business operator terminal 300 transmits bid data for presenting the evaluation value of the used vehicle and the battery to the server device 100. The server device 100 generates or updates the evaluation value data 102B based on the bid data. The server device 100 determines a recycling method (for example, to which business operator to sell) of the target vehicle (or battery) based on the evaluation value data 102B.

The business operator terminal 300 can be configured as a computer including a processor such as a CPU and a GPU, a main storage device such as a RAM and a ROM, and an auxiliary storage device such as a EPROM, a hard disk drive, and a removable medium. Since the configuration of the business operator terminal 300 can be the same as that of the base terminal 200, a detailed description of the configuration will be omitted.

The configuration shown in FIG. 2 is an example, and all or a part of the functions shown in FIG. 2 may be executed using a specially designed circuit. Further, a program may be stored or executed by a combination of the main storage device and the auxiliary storage device other than the functions shown in FIG. 2.

Next, processing executed by each device included in the system will be described.

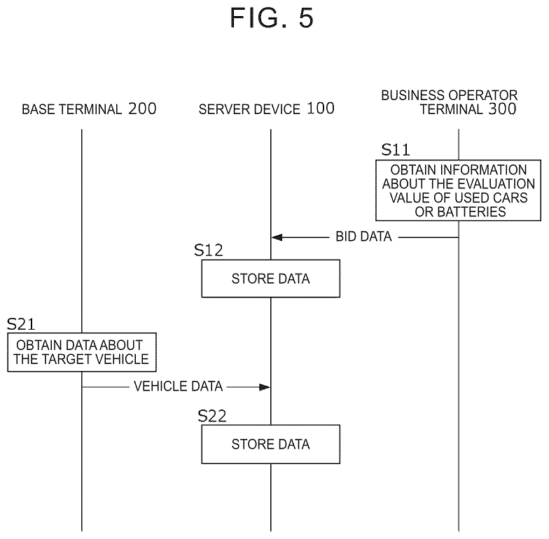

FIG. 5 is a sequence diagram of a process in which the server device 100 receives and updates data from the base terminal 200 or the business operator terminal 300. As described above, data (vehicle data) related to the target vehicle is transmitted from the base terminal 200, and data (bid data) related to the evaluation value of the used vehicle or the battery is transmitted from the business operator terminal 300. These pieces of data are received by the data updating unit 1012 and written into the storage unit 102.

First, in S11, the business operator terminal 300 receives information about an evaluation value of a used vehicle or a battery. In a case where the business operator terminal 300 is associated with a business operator that handles a used vehicle, in this step, for example, the operator of the business operator terminal 300 inputs a model of the vehicle, a condition such as an annual formula, a traveling distance, a color, and a repair history, and an evaluation value as a set to the business operator terminal 300. When the business operator terminal 300 is associated with an operator that handles used batteries, in this step, for example, the operator of the business operator terminal 300 inputs a model of the target battery, a reuse method (resale, rebuild, resource conversion, and the like), a condition such as an SoH and a number of times of charging and discharging, and an evaluation value to the business operator terminal 300.

The evaluation value may be, for example, a maximum amount of money (which may be referred to as a bid amount) that the business operator considers to be able to purchase the used vehicle or battery.

The bid data transmitted from the business operator terminal 300 is received by the server device 100 (the data updating unit 1012) and stored in the storage unit 102 as the evaluation value data 102B in S12. For example, when the transmitted bid data relates to a used vehicle, the used vehicle evaluation value data is an update target. When the transmitted bid data relates to the used battery, the battery evaluation value data is subject to update.

Next, in S21, the base terminal 200 acquires information about the target vehicles. In this step, for example, the operator of the base terminal 200 inputs information about the target vehicle to the base terminal 200. As illustrated in FIG. 3, the input information includes vehicle information and battery information. For example, the operator inputs, as the vehicle information, information on a model, a year, a travel distance, a color, a repair history, and the like of the target vehicle. As the battery information, information on a model, a SoH, a number of times of charging and discharging, a maximum-output, and the like of the battery mounted on the target vehicle are inputted. The base terminal 200 transmits these pieces of information to the server device 100 as vehicle data.

Vehicle data transmitted from the base terminal 200 is received by the server device 100 (data updating unit 1012) and stored in the storage unit 102 as vehicle data 102A in S22.

Note that, in FIG. 5, the process from S11 to S12 and the process from S21 to S22 are described in order, but the respective processes may be performed separately. Further, the process of S12 from S11 may be performed a plurality of times for a plurality of business operator terminals 300.

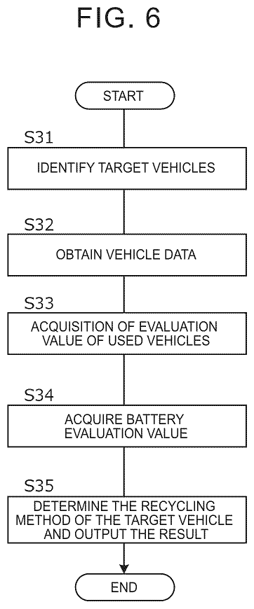

Next, a process in which the server device 100 evaluates the target vehicle will be described. FIG. 6 is a flowchart of processing performed by the server device 100 to evaluate the target vehicle. The illustrated processing is started by the control unit 101 (evaluation unit 1011) when there is a request from the base terminal 200. For example, the request may be issued at a timing at which the process of S22 is completed.

First, the target vehicles are identified by S31. In this step, for example, the evaluation unit 1011 may receive, from the base terminal 200, data for specifying the target vehicle among the plurality of vehicles included in the vehicle data 102A.

Next, in S32, a record corresponding to the target vehicle is extracted from the vehicle data 102A. By executing this step, vehicle information and battery information about the target vehicle are acquired.

S33 uses the acquired vehicle data to acquire an evaluation value of the target vehicle as a used vehicle. In this step, information such as an annual formula and a traveling distance included in the vehicle information is compared with a plurality of conditions included in the used vehicle evaluation value data, and a matching record is extracted to obtain an evaluation value and an identifier of a business operator who presents the evaluation value.

S34 uses the acquired information of the battery to acquire an evaluation value when the target vehicle is viewed as a battery. In this step, SoH included in the battery information, the number of times of charge/discharge, and the like are compared with a plurality of conditions included in the battery evaluation value data, and a matching record is extracted to obtain the evaluation value and the identifier of the business operator who has presented the evaluation value.

By executing S33 and S34, it is possible to acquire the evaluation value (purchase amount) in each of “a case where the target vehicle is sold as a used vehicle” and “a case where the target vehicle is sold as a battery”. The “case of selling the target vehicle as a battery” includes “case of selling the battery on the assumption of resale”, “case of selling the battery on the assumption of rebuilding”, and “case of selling the battery on the assumption of recycling”.

In S35, the recycling methods of the target vehicles, which are the highest in evaluation value, are determined and outputted. In this step, the identifier of the target vehicle or the operator who is the seller of the battery may be simultaneously output together with the evaluation value. Note that the evaluation unit 1011 may output, as an output result, only information related to the recycling method having the highest evaluation value, or may output the highest evaluation value for each recycling method. For example, the evaluation unit 1011 may output the purchase amount in each of “a case where the target vehicle is sold as a used vehicle”, “a case where the battery is sold on the assumption of resale”, “a case where the battery is sold on the assumption of rebuild”, and “a case where the battery is sold on the assumption of resource conversion”.

Thus, the operator of the base terminal 200 can grasp how much value is attached when the target vehicle is sold in what manner.

As described above, in the evaluation system according to the first embodiment, the server device 100 stores both “information for evaluating the value as a used vehicle” and “information for evaluating the value as a battery” for the target vehicle. Then, the server device 100 determines a recycling method that is most valuable for the target vehicle. According to such a configuration, appropriate recycling methods can be proposed for battery electric vehicle that can have various conditions.

### MODIFIED EXAMPLES

The above-described embodiments are merely examples, and the present disclosure may be appropriately modified and implemented without departing from the scope thereof.

For example, the processes and means described in the present disclosure can be freely combined and implemented as long as no technical contradiction occurs.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. The non-transitory computer-readable storage medium is, for example, a disc of any type such as a magnetic disc (floppy (registered trademark) disc, hard disk drive (HDD), etc.), an optical disc (compact disc (CD)-read-only memory (ROM), digital versatile disc (DVD), Blu-ray disc, etc.), a ROM, a random access memory (RAM), an erasable programmable read only memory (EPROM), an electrically erasable programmable read only memory (EEPROM), a magnetic card, a flash memory, an optical card, and any type of medium suitable for storing electronic commands.

What is claimed is:

1. An information processing device comprising a control unit that executes:
obtaining first data relating to a status of a first vehicle including a driving battery;
acquiring second data relating to a status of the driving battery; and
calculating an evaluation value for the first vehicle based on the first data and the second data.

2. The information processing device according to claim 1, wherein the control unit calculates a first evaluation value, which is an evaluation value of the first vehicle as a used vehicle, based on the first data, and calculates a second evaluation value, which is an evaluation value of the driving battery alone, based on the second data.

3. The information processing device according to claim 2, wherein the control unit calculates, as the second evaluation value, any one of an evaluation value in a case where the driving battery is re-distributed, an evaluation value in a case where the driving battery is rebuilt, and an evaluation value in a case where resources are taken out of the driving battery.

4. The information processing device according to claim 3, wherein the control unit determines a recycling method of the driving battery based on the second evaluation value.

5. The information processing device according to claim 2, wherein the control unit acquires a plurality of bid data sets in which the status of the driving battery and the evaluation value are associated with each other from terminals associated with a plurality of business operators, and calculates the second evaluation value based on the second data and the bid data sets.
